(19) United States
(12) Patent Application Publication
(10) Pub. No.: US 2005/0213344 A1
(43) Pub. Date: Sep. 29, 2005

(54) Light source device for illumination

(75) Inventor: Masayuki Inamoto, Saitama-Shi (JP)

Correspondence Address: YOUNG & THOMPSON, 745 SOUTH 23RD STREET, 2ND FLOOR, ARLINGTON, VA, 22202, US

(73) Assignee: FUJINON CORPORATION, SAITAMA-SHI (JP)

(21) Appl. No.: 11/092,559

(22) Filed: Mar. 29, 2005

(30) Foreign Application Priority Data
Mar. 29, 2004 (JP) 2004-096875

(51) Int. Cl. F21V 7/04

(52) U.S. Cl. 362/611

(57) ABSTRACT

An illumination light source device having a light incident opening to which illumination light from a light emitting diode is incident and a light emission opening from which the illumination light incident from the light incident opening is emitted, and having a hollow light guide for guiding the illumination light to an illumination optical system for image projection, characterized in that the light emitting diode is disposed so that the illumination light is irradiated to the light emission opening and the light emission point of the illumination light is located to be shifted to the light emission opening side with respect to the light incident opening.

This application is based on Japanese Patent application JP 2004-096875, filed Mar. 29, 2004, the entire content of which is hereby incorporated by reference. This claim for priority benefit is being filed concurrently with the filing of this application.

### BACKGROUND OF THE INVENTION

1. Technical Field of the Invention

The present invention relates to a light source device for illumination which is used for, for example, a projector or the like.

2. Description of the Related Art

A projector using a liquid crystal panel or DMD (digital micro-mirror device) has been known as a projector for projecting light supplied with information such as an image or the like to a screen to display the image on the screen. According to a liquid crystal projector using a liquid crystal panel, illumination light irradiated to the liquid crystal panel is transmitted through the liquid crystal panel or illumination light irradiated to the liquid crystal panel is reflected by the liquid crystal panel, whereby image information displayed on the liquid crystal panel is projected to the screen. The image information displayed on the liquid crystal panel is displayed on the screen while being enlarged.

The liquid crystal projector is equipped with an illumination light source device for illuminating light to the liquid crystal panel, and an illumination optical system for uniformly irradiating illumination light from the illumination light source device onto the liquid crystal panel is provided in front of the illumination light source device. The illumination optical system contains a lens, a polarization converting element, etc., and the illumination light irradiated from the illumination light source device is irradiated through the illumination optical system to the liquid crystal panel. It is preferable that the liquid crystal panel is illuminated with bright and uniform light, and thus it is desired that the illumination light irradiated from the illumination light source device has high brightness and the light flux thereof is uniform. Accordingly, it has been general to use as the illumination light source device a high-luminance discharge lamp which can light having brightness (high luminance) needed to project an image on the liquid crystal panel such as an ultra-high pressure mercury lamp, a metal halide lamp, a xenon lamp or the like.

The high-luminance discharge lamp is heated, and thus it is necessary to provided a large-scale cooling device for cooling the lamp. However, when the cooling device is provided, there is a problem that the illumination light source device must be designed in a large size and further the manufacturing cost of the projector is increased. Furthermore, it has been required to reduce the cost when the projector is used, for example, to reduce the power to be consumed to irradiate high-brightness light and further to lengthen the period for which the high-luminance discharge lamp can be used.

Therefore, it has been recently considered that a light emitting diode (hereinafter referred to as “LED”) is used as a light source of an illumination light source device in place of the ultra-high discharge lamp. LED has advantages that it is more compact in size, lighter in weight, smaller in power consumption and longer in lifetime, it can be driven with a low voltage and it has a high response speed when it is subjected to turn-on control as compared with the ultra-high discharge lamp described above. However, illumination light emitted from LED is diffused over a broad range, and thus there have been proposed various methods for efficiently condensing diffused light of LED, for example, JP-A-2003-186110 has proposed that illumination light emitted from LED is focused by a lens, and JP-A-2003-177353, JP-A-2003-302702, and Japanese Patent No. 3319438 have proposed that the irradiation direction of illumination light emitted from LED is varied to a predetermined direction.

However, according to the methods disclosed in the above Patent Documents, since the illumination light irradiated from LEDs are condensed at the front side, the illumination light irradiated to the front side of the LEDs can be condensed, however, the light of the LEDs which is diffused over a broad range cannot be sufficiently condensed. Therefore, there is a problem that light having sufficient intensity needed to irradiate light having high brightness cannot be achieved.

### SUMMARY OF THE INVENTION

The present invention has an object to provide an illumination light source device which can irradiate illumination light having high brightness in spite of use of light emitting diodes.

An illumination light source device having a light incident opening to which illumination light from a light emitting diode is incident and a light emission opening from which the illumination light incident from the light incident opening is emitted, and having a hollow light guide for guiding the illumination light to an illumination optical system for image projection, characterized in that the light emitting diode is disposed so that the illumination light is irradiated to the light emission opening and the light emission point of the illumination light is located to be shifted to the light emission opening side with respect to the light incident opening.

It is preferable that a solid light guide is inserted from a light incident face side into the light emission opening to integrate the hollow light guide with the solid light guide.

An illumination light source device having a light incident face to which illumination light from a light emitting diode is incident and a light emission face from which the illumination light incident from the light incident face is emitted, and also having a solid light guide for guiding the illumination light to an illumination optical system for image projection, characterized in that the light incident face is concaved in a spherical shape, and the light emitting diode is disposed so that the illumination light is irradiated to the light emission face and the light emission point of the illumination light is located to be shifted to the light incident face side with respect to the center of the radius of curvature of the sphere.

It is preferable that the light emitting diode is located within a light incident area where the light emission point is surrounded by the light incident face.

As the light guide is preferably used a rod integrator for guiding illumination lights incident from the light incident opening or light incident area to the light mission opening or light emission area while mixing the lights by internal reflection, whereby light having substantially uniform intensity can be emitted.

According to the illumination light source device of the present invention, the illumination light is irradiated to the light emission opening, and also the light emitting diode is disposed so that the light emission point of the illumination light is located to be shifted to the light emission opening side with respect to the light incident opening, so that the illumination light irradiated from the light emitting diode can be prevented from being diffused, and thus light having high brightness and a uniform in-plane brightness distribution can be irradiated in spite of use of the light emitting diode.

Furthermore, the hollow light guide and the solid light guide are integrated with each other by inserting the solid light guide from the light incident face side into the light emission opening, so that physically 100% reflectivity can be achieved in the solid light guide, and thus the incident illumination light can be more efficiently used.

The light incident face is concaved in a spherical shape, and the light emitting diode is disposed so that the illumination light is irradiated to the light emission face and also the light emission point of the illumination light is located to be shifted to the light incident face side with respect to the center point of the radius of curvature of the spherical surface. Therefore, diffused illumination light can be made efficiently incident to the light incident face, and light having high brightness and a substantially uniform in-plane brightness distribution can be irradiated.

The light emitting diode is disposed within a light incident area where the light emission point is surrounded by the light incident face, so that the diffused illumination light can be made efficiently incident to the light incident face and light having high brightness and a uniform in-plane brightness distribution can be irradiated.

### BRIEF DESCRIPTION OF THE DRAWINGS

FIG. 1 is a diagram showing the construction of a projector.

FIG. 2 is a diagram showing an intensity distribution of illumination light irradiated from a white LED.

FIG. 3 is a cross-sectional view showing a rod integrator when an incident face is concaved in a spherical shape.

FIG. 4 is a cross-sectional view showing a hollow rod integrator.

FIG. 5 is an exploded perspective view showing a rod integrator when a hollow rod integrator and a solid rod integrator are combined with each other.

FIG. 6 is a cross-sectional view showing a rod integrator when a hollow rod integrator and a solid rod integrator are combined with each other.

FIG. 7 is a cross-sectional view showing a modification of the rod integrator when the hollow rod integrator and the solid rod integrator are combined with each other.

### DETAILED DESCRIPTION OF THE INVENTION

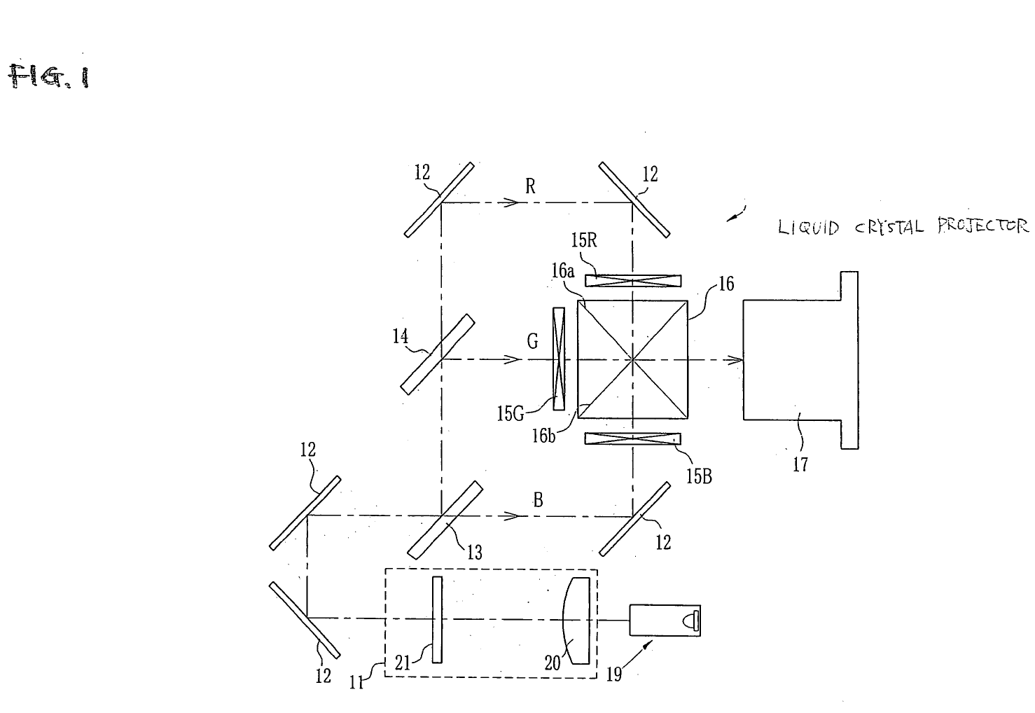

In FIG. 1, a liquid crystal projector 10 is equipped with an illumination optical system 11 for image projection, a mirror 12 for varying an irradiation direction of irradiated illumination light, dichroic mirrors 13, 14, three transmission type liquid crystal panels (image display elements) 15R, 15G, 15B, a cross dichroic prism 16, a projection lens 17, a screen 18 and an illumination light source device 19 of the present invention.

The illumination optical system 11 is equipped with a lens 20 and a polarization converting element 21. White light containing red light (R light), green light (G light) and blue light (Blight) are irradiated from the illumination light source device 19 to the downstream side thereof. The illumination light irradiated from the illumination light source device 19 is incident to the lens 20. The illumination light incident to the lens 20 is collimated and then irradiated to the downstream side of the lens 20. The polarization converting element 21 is disposed at the downstream side of the lens 20. The polarization converting element 21 transmits illumination light irradiated from the illumination light source device 19 therethrough to convert the illumination light to R light, G light and B light having no specific polarization plane to S-polarized light. Each color illumination light transmitted through the polarization converting element 21 is reflected by the mirror 12 and then incident to the dichroic mirror 13.

The dichroic mirror 13 transmits B light contained in white light and reflects R light and G light to separate the B light. The B light thus separated is reflected by the mirror 12 and incident to the liquid crystal panel 15B. The R light and the G light reflected by the diachronic mirror 13 are incident to the diachronic mirror 14. The diachronic mirror 14 transmits the R light therethrough and reflects the G light to separate the R light and the G light from each other. The R light transmitted through the dichroic mirror 14 is reflected from the mirror 12, and incident to the liquid crystal panel 15R. The G light reflected by the dichroic mirror 14 is incident to the liquid crystal panel 15G.

In the liquid crystal panels 15R, 15G, 15B, the R light, the G light and the B light incident thereto are supplied with image information. The light flux of the R light, the G light and the B light transmitted through the liquid crystal panels 15R, 15G, 15B is incident to the cross dichroic prism 16. The cross dichroic prism 16 comprises a combination of four rectangular prisms. The cross dichroic prism 16 has two kinds of dichroic faces of a R light reflection face 16a for reflecting R light and a B light reflection face 16b for reflecting B light, and the orthogonal prisms thereof are arranged so that the R light reflection face 16a and the B light reflection face 16B are orthogonal to each other.

When the R light transmitted through the liquid crystal panel 15R is reflected by the R light reflection face 16a, the irradiation direction of the R light is varied so as to be orthogonal to the transmission direction of the R light through the liquid crystal panel 15R so that the reflected R light is directed to the projection lens 17, and thus the R light is incident to the projection lens 17. The G light transmitted through the liquid crystal panel 15G is transmitted through the R light reflection face 16a and the B light reflection face 16b, straightly travel and then are incident to the projection lens 17. When the B light transmitted through the liquid crystal panel 15B is reflected by the B light reflection face 16b, the irradiation direction of the B light is varied so as to be orthogonal to the transmission direction of the B light through the liquid crystal panel 15B so that the reflected B light is directed to the projection lens 17, and thus the B light is incident to the projection lens 17. The projection lens 17 projects the light flux of the respective color light combined by the cross dichroic prism 16 while enlarging each color light flux, and focuses them onto the screen 18 (not shown), whereby the image information is displayed on the screen 18.

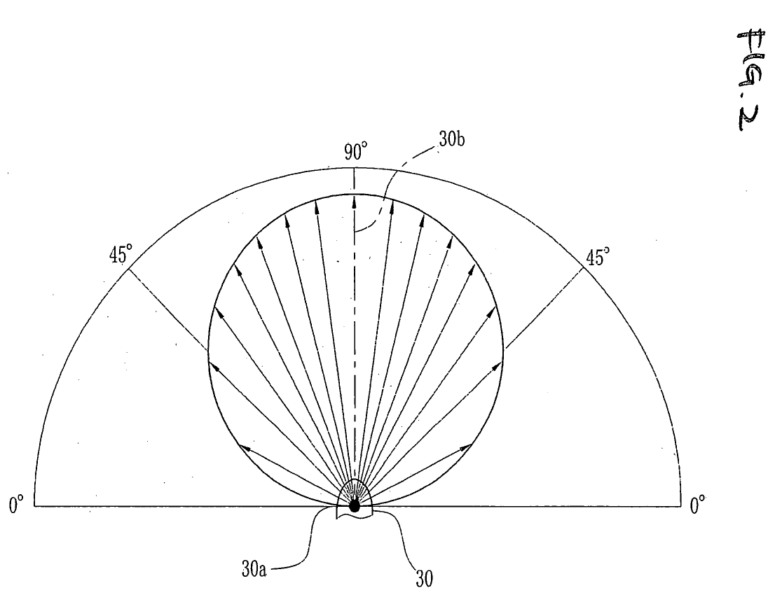

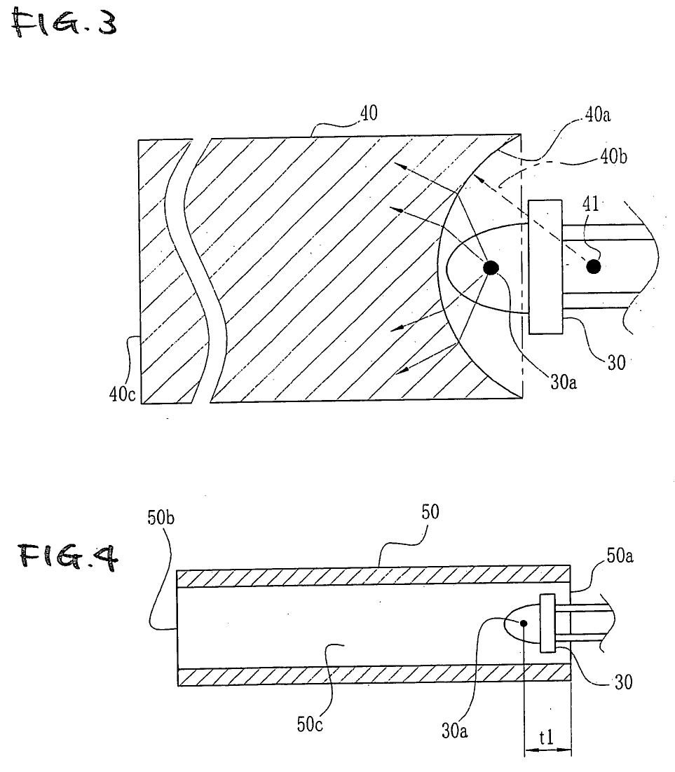

As shown in FIGS. 2 and 3, the illumination light source device 19 is equipped with a white LED 30 and a rod integrator (light guide) 40 described later. The light emission point 30a of the white LED 30 is located at the center of the intensity distribution of the illumination light and also located within the irradiation range of the illumination light, and the illumination light is irradiated from the light emission point 30a in the white LED 30. The illumination light irradiated from the white LED 30 has a characteristic that the intensity thereof is highest on the main irradiation optical axis 30b passing through the center of the intensity distribution of the illumination light and gradually reduced from the main irradiation optical axis 30b to the periphery thereof (a portion surrounded by a heavy line of the figure represents an intensity distribution of illumination light). Therefore, if the illumination light irradiated from the white LED 30 is used without using the rod integrator 40, image information on the screen 18 is bright at the center portion thereof, but gradually darkened toward the peripheral portion thereof. Accordingly, in the liquid crystal projector 10, the illumination light source device 19 is equipped with the rod integrator 40 (see FIG. 3) in addition to the white LED 30, whereby image information having uniform brightness can be achieved. As the white LED 30 may be used as a member for irradiating white light independently by using ultraviolet light and fluorescent material or a member of irradiating white light by mixing R light, G light and B light with one another.

As shown in FIG. 3, the rod integrator 40 is formed of transparent material and designed to have a quadratic-prism shape. A surface of one end side of the rod integrator 40 in the longitudinal direction serves as a light incident face 40a to which illumination light from the white LED 30 is incident. The light incident face 40a is designed to be concaved in a spherical shape. The rod integrator 40 is designed so that an area thereof surrounded by the light incident face 40a serves as a light incident area 40b, and a surface thereof at the opposite side to the light incident face 40a serves as a light emission face 40c for emitting illumination light incident from the light incident face 40a.

The white LED 30 is disposed so that the light emission point 30a is located to be shifted to the light incident face 40a with respect to the center point 41 of the radius of curvature of the light incident face 40a and also located within the light incident area 40b. Accordingly, the illumination light irradiated from the white LED 30 is internally reflected at a larger incident angle in the rod integrator 40, so that high reflectivity can be achieved and the illumination of the white LED 30 can be efficiently condensed. The illumination lights incident from the light incident face 40a are mixed in the rod integrator 40, emitted from the light emission face 40c and then guided to the illumination optical system 11. As the material for the rod integrator 40 may be used any proper material different in light refractive index from air, for example, glass, transparent resin such as acrylic resin or the like.

Next, the operation of the liquid crystal projector having the illumination light source device of the present invention thus constructed will be described. When illumination light is irradiated from the white LED 30, the illumination light thus irradiated is internally reflected and mixed in the rod integrator 40, and then irradiated and the illumination lights thus reflected are mixed, and then emitted as light having substantially uniform intensity from the light emission face 40c to the outside, whereby the irradiation direction of the illumination light irradiated from the white LED 30 is varied, and the illumination light is irradiated with substantially uniform brightness in a predetermined range. The illumination light irradiated from the rod integrator 40 is passed through the dichroic prism 16 and the projection lens 17 onto the screen 18.

Next, a case where the rod integrator is formed in a hollow shape will be described. As shown in FIG. 4, a rod integrator formed in a hollow shape is designed so that the opening at one end side thereof serves as a light incident opening 50a to which illumination light from the external is incident, and an opening at the opposite side to the light incident opening 50a serves as a light emission opening 50b from which the incident illumination light is emitted. The light incident opening 50a and the light emission opening 50b intercommunicate with each other through a light guide passage 50c, and light incident from the light incident opening 50a passes through the light guide passage 50c and is irradiated from the light emission opening 50b to the outside. A white LED 30 is disposed in the light guide passage 50c so that the light emission point 30a thereof is located to be shifted to the light emission opening 50b with respect to the light emission opening 50a. That is, the white LED 30 is disposed so that the distance t1 between the light incident opening 50a and the light emission point 30 shown in FIG. 4 satisfies t1>0. Accordingly, illumination lights which are emitted not only frontward, but also laterally can be prevented from being diffused before they are incident into the rod integrator 50, and thus the illumination light from the white LED 30 can be efficiently condensed. When a hollow rod 62 is used, the internal reflection frequency of illumination light is larger than that when the solid rod integrator 31 is used, and thus illumination light having more uniform intensity can be achieved when light is irradiated from the irradiation face.

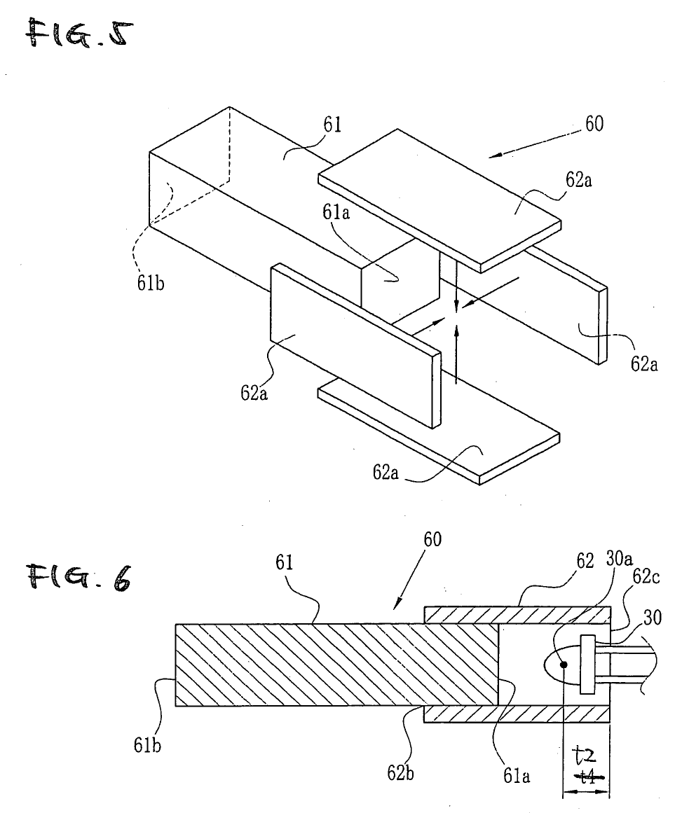

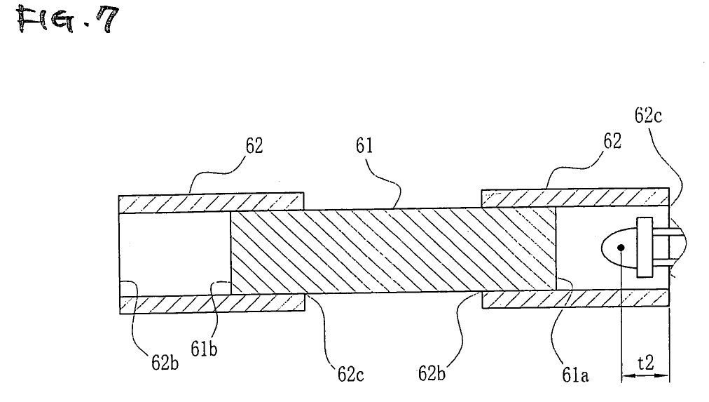

Next, a case where the hollow rod integrator and the solid road integrator are combined with each other will be described. As shown in FIGS. 5 and 6, the rod integrator 60 is formed by integrating the solid rod 61 having a quadratic-prism shape and the hollow rod 62 with each other. One end side of the solid rod 61 serves as a light incident face 61a, and the other side thereof serves as a light emission face 61b.

The hollow rod 62 comprises four transparent plates 62a. Each transparent plate 62a is partially attached to each surface of the solid rod 61 so as to project to the light incident face 61a side of the solid rod 61. When the transparent plates 62a are attached, the end edges of the respective plates are brought into contact with one another to form a hollow shape. One opening of the hollow rod 62 at which the solid rod 61 is inserted serves as a light emission opening (light emission area) 62b, and the opening thereof at the opposite side serves as a light incident opening (light incident area) 62c. Therefore, under the state that the solid rod 61 and the hollow rod 62 are integrated with each other, the solid rod 61 is set to be inserted in the light emission opening 62b from the light incident face 61a side.

The hollow portion of the hollow rod 62 serves as a light guide passage 62d. The light incident opening 62b intercommunicates with the light guide passage 62d, and illumination light incident from the light incident opening 62b is incident through the light guide passage 62d to the light incident face 61a. The light incident to the light incident face 61a is emitted from the light emission face 61b to the outside. The white LED 30 is located in the light guide passage 62d so that the light emission point 30a thereof is located t-o be shifted to the light emission opening 62b side with respect to the light incident opening 62c. That is, the white LED 30 is disposed so that the distance t2 between the light incident opening 62c and the light emission point 30a shown in FIG. 7 satisfies t2>0. Accordingly, the illumination light irradiated from the white LED 30 is internally reflected at a larger incident angle in the rod integrator 60, and thus high reflectivity can be achieved, so that the illumination light of the white LED 30 can be efficiently condensed.

As shown in FIG. 7, the hollow rods 62 may be fixed both the end sides of the solid rod 62. In this case, illumination light emitted from the light emission face 61b of the solid rod 61 is internally reflected in the hollow rod 62, so that adhesion of dust to the light emission face 61b and damage of the light emission face 61b can be prevented.

In the above embodiment, only the white LED 30 for irradiating white light is provided to project image information. However, at least two kinds of LEDs which are different in emission light color may be provided. For example, when LEDs for irradiating R light, G light and B light respectively are provided and the colors of the illumination lights irradiated from the respective LEDs is switched to one another every predetermined time, a time-division color system of a single plate can be implemented. In this case, the dichroic mirrors 13, 14, the cross dichroic prism 16, etc. can be omitted, and only one liquid crystal panel may be used. Therefore, the manufacturing cost of the liquid crystal project can be reduced. Furthermore, at least one white LED and one red LED are provided and turned on at the same time. In this case, redness which is liable to be insufficient when only the white LED is used can be added, and color reproduction performance of image information to be projected can be enhanced.

In the above embodiment, the present invention is not limited to the transmission type liquid crystal projector in which light irradiated to a liquid crystal panel is transmitted therethrough, and it may be applied to a reflection type liquid crystal projector in which illumination light irradiated to a liquid crystal panel is reflected therefrom, a projector using DMD or other projectors.

1. An illumination light source device comprising:
a light emitting diode; and
a hollow light guide that guides illumination light to an illumination optical system for image projection, the hollow light guide having
a light incident opening to which the illumination light from the light emitting diode is incident, and
a light emission opening from which the illumination light incident from the light incident opening is emitted,
wherein the light emitting diode is disposed so that the illumination light is irradiated to the light emission opening and a light emission point of the illumination light is located to a light emission opening side with respect to the light incident opening.

2. The illumination light source device according to claim 1, which further comprises a solid light guide.

3. The illumination light source device according to claim 2, wherein the solid light guide is partially disposed in the hollow light guide so that a light incident face of the solid light guide is located at the light emission opening side of the hollow light guide.

4. The illumination light source device according to claim 3, wherein the solid light guide and the hollow light guide are integrated with each other.

5. An illumination light source device comprising:
a light emission diode; and
a solid light guide that guides illumination light to an illumination optical system for image projection, the solid light guide having
a light incident face to which the illumination light from the light emitting diode is incident and
a light emission face from which the illumination light incident from the light incident face is emitted,
wherein the light incident face is concaved in a spherical shape, and the light emitting diode is disposed so that the illumination light is irradiated to the light emission face and a light emission point of the illumination light is located to a light incident face side with respect to a center of a curvature radius of the spherical shape.

6. The illumination light source device according to claim 5, wherein the light emitting diode is located within a light incident area where the light emission point is surrounded by the light incident face.
